(19) United States
(12) Patent Application Publication
(10) Pub. No.: US 2011/0285604 A1
(43) Pub. Date: Nov. 24, 2011

(54) RADOME FOR BROADBAND PARABOLIC ANTENNA

(76) Inventors: Armel Le Bayon, Trignac (FR); Denis Tuau, Trignac (FR)

(21) Appl. No.: 13/132,473

(22) PCT Filed: Dec. 10, 2009
(86) PCT No.: PCT/FR2009/052486

§ 371 Date: Aug. 16, 2011

(30) Foreign Application Priority Data
Dec. 11, 2008 (FR) 0858499

(51) Int. Cl. H01Q 1/42

(52) U.S. Cl. 343/872

(57) ABSTRACT

The object of the present invention is a rigid radome for a broadband parabolic antenna. The radome has a roughly circular shape, and is bent along a diameter towards the interior of the antenna, thereby forming two half-disks. The two half-disks form an angle less than or equal to 12° with the plane perpendicular to the antenna's axis. The radome is made up of a sandwich-style multilayer material, comprising two outer layers surrounding at least one central pitted layer, whose pits have a roughly conical shape.

The present invention pertains to a radome for a parabolic antenna enabling a usage over a broad band of frequencies (5 to 25 GHz). It further expands to an antenna equipped with that radome.

Parabolic antennas are commonly used as radio communication antennas. Such an antenna comprises a main reflector exhibiting a concavity having the shape of a paraboloid of revolution around that antenna's axis of symmetry. The periphery of the parabola is most commonly equipped with a cylindrical wall, also known as a shroud, which in particular limits the antenna's lateral radiation and thereby improves its performance. The presence of the shroud increases the antenna's wind surface and the risk that polluting elements could accumulate. For this reason, the shroud is associated with a radome which exhibits an impermeable protective surface closing off the space defined by the reflector and the shroud vis-à-vis the outside. This radome may be flexible or rigid.

A radome made up a flexible materials such as a cloth has a limited production cost and a lower form factor prior to being installed on the antenna. It also has the advantage of being sufficiently transparent with respect to the wave transmitted by the antenna over a bandwidth covering different radio communication applications. However, the radome's surface, by reflecting the waves, disrupts the antenna's operation and may reduce its performance. In order to limit these disruptions, it is known to incline the radome's surface in relation to the antenna's axis in order to introduce a phase shift between the reflected waves such that the disruptions caused by these reflected waves cannot accumulate with one another. However, such a flexible radome exhibits drawbacks related to relative fragility and a complex system of fastening onto the antenna's shroud, requiring self-stretching elements in order to stretch it and keep it so, such as springs.

A rigid radome exhibits the advantage of good resistance to the outside climate environment, such as rain, wind or snow. A rigid radome exhibits a symmetrical surface compared to the antenna's axis. The most commonly used rigid radomes are conical, such as the one described in the patent U.S. Pat. No. 7,042,407. The radome is made of a dielectric material, such as a polymer (polycarbonate, ASA, ABS, PS, PVC, PP, . . . ), fiberglass, etc. A conical radome may be injection-molded or thermoformed. When the material does not permit it or the diameter is too great, the radome can only be flat. However, this radome shape exhibits the same drawbacks as the flexible radome, i.e. insufficient performance due to the reflections that it causes. The solution analogous to that applied to the flexible radome, consisting of inclining the radome's surface with respect to the antenna's axis, is not satisfactory. In particular, it has the default of increasing the antenna's form factor.

It is known, for example from the document EP-1 796,209, to have rigid radomes exhibiting a circular-symmetry concavity relative to the antenna's axis, which makes it possible to place it on a shroud without considering the radome's orientation compared to the antenna's axis.

Nonetheless, the thickness of the material that is used in a rigid radome is problematic, because that thickness is determined based on the frequency band used by the antenna. For example, the thickness of a rigid radome implemented in an antenna transmitting with a wavelength on the order of 40 GHz is practically twice less great than the thickness of a rigid radome of the same nature implemented in an antenna transmitting with a wavelength on the order of 20 GHz. It is understood that in order to use the antenna over a broad band of frequencies, which may run from 5 to 25 GHz, it is necessary to use five radomes of different thicknesses. These radomes must be taken off and replaced each time the frequency domain is changed.

Furthermore, a radome must exhibit the following qualities:
great transparency to radio waves over the largest possible bandwidth,
good mechanical resistance to loads greater than 300 Kg/m², which corresponds to 250 Km/h winds,
sufficient stability with regard to ultraviolet (UV) rays, rainfall, salt mists, and temperature differences in the range of −45° C. to +70° C.,
the lowest possible cost, particularly with regard to large-diameter radomes.

It is a goal of the present invention to eliminate the drawbacks of the prior art, by proposing a rigid radome enabling the operation of a parabolic antenna in a greater frequency domain than the prior art, without it being necessary to change that radome.

The object of the present invention is a circular rigid radome for a broadband parabolic antenna, characterized in that it is bent along a diameter towards the interior of the antenna, thereby forming two half-disks.

According to one embodiment of the invention, the two half-disks form an angle less than or equal to 12° with the perpendicular plane of the antenna's axis. This angle is preferentially between 4° and 12°. This particular form of the radome allows the reflected waves to be absorbed by the shroud. Thus, the reflected waves no longer cause disruptions.

The bending may be obtained by mechanical or thermal action on the radome's material.

A radome material's main property must be that it is as transparent as possible vis-à-vis the waves. It must also have sufficient mechanical rigidity and good resistance to environmental conditions lasting several years. Naturally, an inexpensive, easy-to-work material will preferentially be chosen.

A further object of the present invention is therefore a radome for a broadband parabolic antenna as previously described, made up of a multilayer sandwich-style material comprising two outer layers surrounding at least one pitted central layer whose pits have a roughly conical shape. This shape considerably improves the passage of electromagnetic waves.

Preferentially, the outer layers are continuous flat plates made of a polymer material. Even more preferentially, the three-dimensional central layer is made of the same material. This polymer material is preferentially polypropylene (PP) because this is an inexpensive material that exhibits excellent radio qualities (dielectric constant of PP: εᵣ=2.3).

A multilayer material has the advantage of good mechanical solidity and improved radio performance compared with a single-layer material. However, it is thicker, heavier, and more expensive. Furthermore, the radio performance may be degraded by the dielectric material of the central layers. A sandwich material whose central layer contains little matter, such as is the case with a foam or honeycomb, no longer exhibits this drawback, but it remains expensive and its mechanical resistance is lower.

The material of the inventive radome comprises very thin outer layers which are favorable to the antenna's operation across a broad frequency band. The inner layer contains a high proportion of air, which makes it lightweight. The material possesses a low dielectric constant, on the order of that of air (dielectric constant of air: εᵣ=1). The polymer that is used contributes to reducing the radome's cost.

According to one preferred embodiment of the invention, the pits have the shape of a truncated cone comprising a step at mid-height. This particular shape of the pits makes the material highly mechanically resistant and improves the passage of electromagnetic waves.

A further object o the invention is a parabolic antenna capable of operating within the frequency domain of 7-25 GHz equipped with a radome having a roughly circular shape, bent along a diameter towards the interior of the antenna.

Other characteristics and advantages of the invention will become apparent while reading the following description of embodiments, which are non-limiting and given for purely illustrative purposes, and in the attached drawing, in which.

Other characteristics and advantages of the present invention will become apparent upon reading the following description of one embodiment, which is naturally a non-limiting example and given for purely illustrative purposes, and in the attached drawing, in which:

FIG. 1 is a cross-section view of an antenna bearing a radome according to one embodiment of the invention,

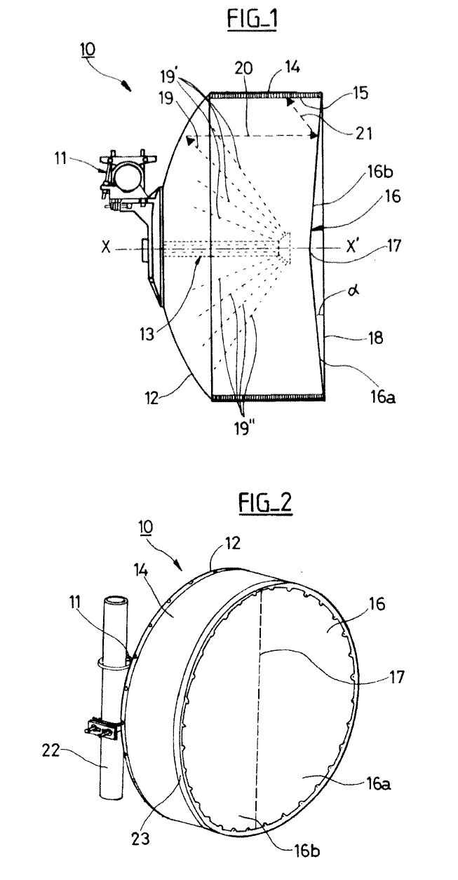

FIG. 2 is a perspective view of the antenna from FIG. 1,

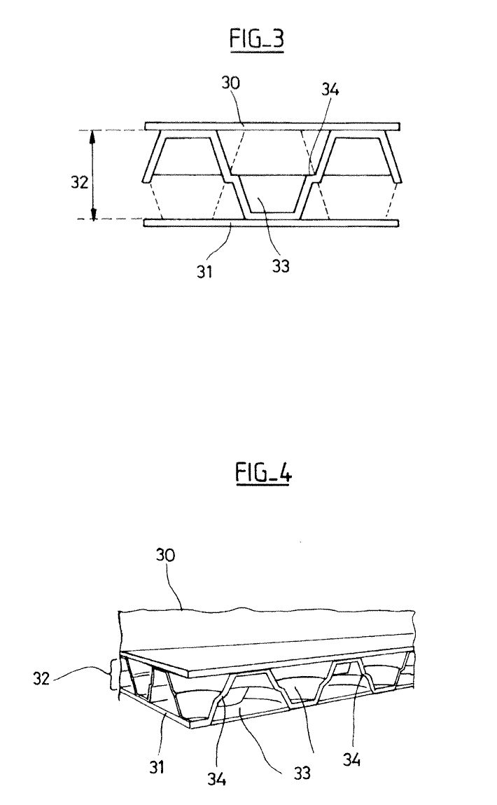

FIG. 3 is a cross-section view of the material of the radome according to one embodiment of the invention,

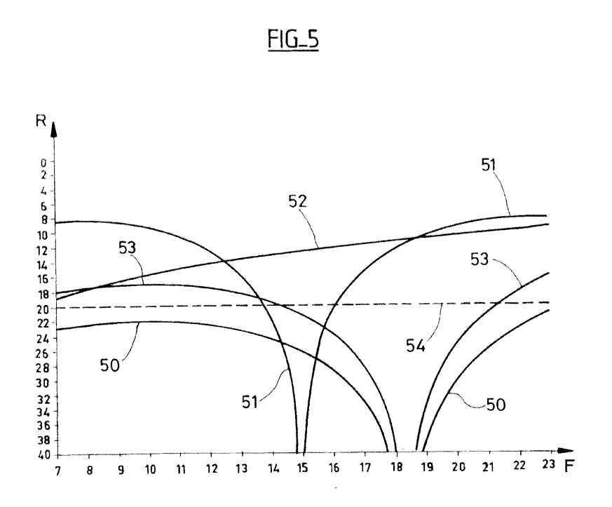

FIG. 4 is a perspective view of the body material of the radome from FIG. 3,

FIG. 5 shows a comparison between the radio performance of the radome according to one embodiment of the invention and that of the radomes of the prior art, FIG. 5 shows the reflection coefficient R in dB on the y-axis and the frequency F in GHz on the x-axis.

In the embodiment of the invention depicted in FIG. 1, an antenna 10 equipped with its fastening means 11, such as for fastening onto a mast, is depicted in cross-section. The antenna 10 comprises a parabolic reflector 12 in the center of which is placed a waveguide 13. A shroud 14, covered on the inside by an absorptive coating 15, is fastened on to the periphery of the parabolic reflector 12. A radome 16 fastened at its periphery onto the shroud 14 covers the parabola 12.

The radome 16 comprises a bend 17 along one of its diameters defining two half-disks 16a and 16b. The two half-disks 16a and 16b form an angle α of between 4° and 12° with the plane 18 perpendicular to the antenna's axis. This shaping of the radome 16 enables a wave 19 emitted by the waveguide 13 to be reflected off the parabolic reflector 12, then to move (arrow 20) towards the radome 16 off which it is again reflected. Owing to the invention, the wave is directed (arrow 21) towards the absorptive coating 15 of the shroud 14 into which it is absorbed without creating disruptions in the waves 19, 19′, 19″ emitted by the waveguide 13.

FIG. 2 shows a perspective view of the antenna 10 from FIG. 1, equipped with its radome 16, fastened onto a mast 22 by the fastening means 11 that it bears. The radome 16 is fastened onto the periphery of the shroud 14 by means of an injected plastic ring 23 whose shape is adapted.

We will now consider FIGS. 3 and 4, which are respectively a cross-section view and a partial perspective view of the material that makes up the radome. This material comprises an upper layer 30 made up of a flat plate of polymer material, such as polypropylene, and a lower layer 31 made up of a plate of polymer material that may be similar to or different from that of the layer 30. In order to optimize the antenna's broadband characteristics, the outer layers 30, 31 must be thin and have a very low dielectric constant. The layers 30 and 31 here have a thickness of about 0.55 mm. The layers 30 and 31 surround a middle layer 32 formed of air-filled pits 33. The middle layer 32 has a thickness of between 3.8 mm and 4.7 mm, and a low dielectric constant εᵣ on the order of 1. The pits 33 are roughly conical in shape, the truncated cones being arranged alternately in one direction and the other. Preferentially, the walls of the cones are made of a polymer material, such as polypropylene, and have a constant thickness in order to facilitate the welding or gluing of the layer 32 onto the layers 30 and 31. The pits 33 are filled with air in order to make the radome lighter.

According to one preferential embodiment, the pits comprise a step 34 situated roughly mid-height on the cones. This step makes it possible to rigidify the walls of the pits and strengthen the mechanical resistance of the middle layer 32 and of the whole material.

In such a material, the bending of the radome along one of its diameters may be obtained by mechanical or thermal action on the material. The mechanical action may, for example, be cold-bending, and the thermal action may, for example, be running a hot-roller over the material.

In FIG. 5, the radio performance of the radome according to the embodiment of the invention (curve 50) depicted in the previous figures is compared with those of known radomes (curves 51 to 53). The reflection coefficient R has been depicted as a function of the incident wave's frequency F on the radome. The curve 54 shows the limit of acceptable performance for a radome, which corresponds to a reflection coefficient of −20 dB. Beyond that value, the antenna's radiation pattern or return loss might be disrupted.

The curve 51 corresponds to the result obtained with a flat, rigid radome whose thickness is on the order of half a wavelength (εᵣ=2.3). Radomes of this type normally have a small diameter of 0.3 m to 1.8 m (1 ft to 6 ft). Because of the narrowness of the frequency band in which it operates, this radome is generally conical in shape. This radome is made of an injected or thermoformed polymer (ABS, PS, PVC, PP, . . . ). It is observed that this radome's effectiveness is limited to a narrow frequency band of between about 14 GHz and 16 GHz.

The curve 52 corresponds to the operation of a flexible radome with a very thin wall having a thickness on the order of about one-tenth of the wavelength (about 0.8 mm thick, εᵣ=3). Radomes of this type normally have a large diameter of 1.2 m to 4.6 m (4 ft to 15 ft). This radome's performance is above the curve representing the limit of acceptable performance.

The curve 53 represents the performance of a flat radome made up of a material similar to that of the FIGS. 3 and 4 (εᵣ=1). This radome shifts the usable frequency band up to higher values than with the curve 51. However, this radome's effectiveness is limited to a frequency band of between about 14.5 GHz and 21 GHz.

In the studied frequency range (7 to 23 GHz), the performance of the radome represented by the curve 50 is always below the limit of acceptable performance represented by the curve 54. It is understood that a radome according to one embodiment of the invention is effective over a considerably wider frequency band than the radomes of the prior art, and therefore makes it possible to work on that entire band without it being necessary to change the radome.

1. A circular rigid radome for a broadband parabolic antenna, wherein the radome is bent along a diameter towards an interior of the antenna, thereby forming two half-disks.

2. A radome according to claim 1, wherein the two half-disks form an angle less than or equal to 12° with the perpendicular plane of the antenna's axis.

3. A radome according to claim 1, made up of a sandwich-style multilayer material, comprising two outer layers surrounding at least one central pitted layer, whose pits have a roughly conical shape.

4. A radome according to claim 3, wherein the outer layers and central layer are made of a polymer.

5. A radome according to claim 4, wherein the outer layers and central layer are made of polypropylene.

6. A radome according to claim 3, wherein the pits have the shape of a truncated cone comprising a step at mid-height.

7. A parabolic antenna capable of operating within the frequency domain of 7-25 GHz equipped with a radome having a roughly circular shape and bent along a diameter towards the interior of the antenna.

8. A parabolic antenna according to claim 7, wherein the radome is made up of a sandwich-style multilayer material, comprising two outer layers surrounding at least one central pitted layer, whose pits have a roughly conical shape.
